(19) United States
(12) Patent Application Publication
(10) Pub. No.: US 2014/0014376 A1
(43) Pub. Date: Jan. 16, 2014

(54) ELECTROCHEMICAL ENERGY STORE HAVING A PLURALITY OF ELECTROCHEMICAL CELLS

(71) Applicant: Tim Schaefer, Harztor (DE)

(72) Inventor: Tim Schaefer, Harztor (DE)

(73) Assignee: LI-TEC BATTERY GMBH, Kamenz (DE)

(21) Appl. No.: 13/817,418

(22) PCT Filed: Aug. 17, 2011
(86) PCT No.: PCT/EP2011/004148

§ 371 Date: Oct. 2, 2013

(30) Foreign Application Priority Data
Aug. 19, 2010 (DE) 10 2010 034 826.0

(51) Int. Cl. H01M 10/42

(52) U.S. Cl. CPC H01M 10/42
USPC 169/46; 429/149; 429/160; 29/623.1

(57) ABSTRACT

In an electrochemical energy store having a multiplicity of electrochemical cells (2) and intermediate elements (7-17) between in each case two adjacent electrochemical cells or between an electrochemical cell and a housing wall, said intermediate elements are composed of an extinguishing agent or an extinguishing agent additive or comprise or have an extinguishing agent or an extinguishing agent additive.

The present invention relates to an electrochemical energy store. Preventing and/or fighting fire are of special importance in conjunction with such energy stores. Preventing or fighting fire is a particularly important instrument for increasing the safety of such electrochemical energy stores, particularly when the energy stores are used in vehicles transporting passengers.

DE 10 2008 059 948 A1 discloses a method and an apparatus for preventing and/or fighting fire for a lithium ion battery of a vehicle, a motor vehicle in particular, in which the interior of the battery comprising individual cells of the battery is connected to an extinguishing agent storage via an emergency line and in which the battery interior and the extinguishing agent storage are at least temporarily fluidically connected by means of an emergency opening.

DE 10 2008 059 942 A1 discloses a method and an apparatus for preventing and/or fighting fire in a vehicle having a coolant circuit and a fire extinguisher apparatus. The fire extinguisher apparatus is provided with emergency openings which are opened to fight or prevent fire and through which an extinguishing agent can be dispensed.

DE 10 2008 059 968 A1 discloses a method and an apparatus for operating a lithium ion battery of a vehicle, in which for fire prevention and/or firefighting purposes, the interior of the battery comprising the individual cells of the battery is fluidically connected to a coolant circuit of the battery by a line and the refrigerant is at least temporarily introduced into the interior from the coolant circuit when needed.

The present invention is based on the object of specifying a technical teaching for preventing and/or fighting fire in conjunction with electrochemical energy stores and thereby overcoming as many limitations or disadvantages of the known solutions as possible.

This object is accomplished by an electrochemical energy store, or a method for its manufacture respectively, or by a method for fighting or preventing fire in conjunction with electrochemical energy stores in accordance with any one of the independent claims. The subclaims are intended to protect advantageous further developments of the invention.

According to the invention, an electrochemical energy store is provided with a plurality of electro-chemical cells and intermediate elements between each two respective adjacent electrochemical cells or between an electrochemical cell and a housing wall, wherein said intermediate elements consist of an extinguishing agent or an extinguishing agent additive or contain or comprise an extinguishing agent or extinguishing agent additive. The intermediate elements are preferably designed in the form of spacers or edge protection plates.

In conjunction hereto, an electrochemical energy store is to be understood as a device which stores energy in chemical form and can emit said energy in electrical form to an external electrical load. Fuel cells and galvanic cells as well as aggregates of a plurality of such cells are notable examples of such energy stores. The cells are thereby preferably secondary cells; i.e. electro-chemical energy stores which not only can emit energy stored in chemical form to a load in electrical form but which when provided with electrical energy, can also store it in chemical form; i.e. can also be charged.

In the present context, a fire refers to any action which alters or disintegrates the energy store or parts of the energy store or its surroundings by an unwanted chemical reaction. Fires in this sense are in particular exothermic chemical reactions of elements or components of an energy store or its environment which frequently occur as a consequence of the energy store or its components being overheated.

To be understood by an extinguishing agent in this context is a substance or a mixture of substances which exerts an extinguishing effect on fire; i.e. preferably a retarding effect, and/or which prevents or impedes fires from starting. In conjunction with the present invention, an extinguishing effect preferably refers to an action which counteracts fire; i.e. which can prevent or lessen the consequences or the onset of fire. Important examples of extinguishing agents or the preferred substances they contain are substances which deprive a source of fire of a chemical reactant without which the fire cannot maintain itself or which inhibits a chemical reaction conducive to the initiating or feeding of a fire. Extinguishing agents are preferably produced by mixing an extinguishing agent additive with a solvent or a carrier.

Preferential extinguishing agent additives in conjunction with the present invention are so-called gelling agents which when coupled with other materials, solvents or carriers such as preferably water, form preferably adherent and preferably viscous gels or viscoelastic fluids which are preferably characterized by their adhesiveness to burning objects and their surfaces. Gelling agents are preferential examples of extinguishing agent additives based preferably on so-called superabsorbents and preferably provided as powder or solid material or also as emulsions. Superabsorbents can often absorb many times their weight or volume in water or other carrier substance. Compared to conventional blankets of foam, water-based gels formed by mixing corresponding superabsorbents with water have the advantage of forming a hermetic barrier which lasts longer than conventional foam blankets and dowses the burning object with significantly less water.

In conjunction with the description of the present invention, viscoelastic fluid is to be understood as a fluid exhibiting the property of viscoelasticity. An (ideal) fluid is to be understood as a substance which exhibits (more or less) no resistance to any given slow shearing. A differentiation is made between compressible fluids (gases) and incompressible fluids (liquids). The umbrella term “fluid” is used because most physical laws apply (more or less) equally to gases and liquids and many of their properties only differ quantitatively but generally not qualitatively. Based on their behavior, real fluids can be divided into “Newtonian fluids” with their characteristic fluid mechanics and non-Newtonian fluids with their characteristic rheology. The difference between them lies in the flow behavior of the medium, characterized by the functional correlation between shear or shearing stress and distortion or shear rate.

Viscoelasticity denotes the time, temperature and/or frequency-dependent elasticity of fluids such as e.g. of polymer melts or solid bodies such as e.g. plastics. Viscoelasticity is characterized by partly elastic, partly viscous properties. The material only partially returns to its initial state after an external force is eliminated; the remaining energy is depleted in the form of flow processes.

In the context of the description of the present invention, a gel is to be understood as a finely dispersed system of at least one first, often solid, and at least one second, often liquid, phase. A colloid frequently constitutes a gel. The solid phase thereby forms a sponge-like, three-dimensional network, the pores of which are filled with a liquid or also a gas. Both phases thereby frequently interpermeate completely. Colloids are identified as particles or droplets finely distributed within another medium (solid, gas or liquid), the dispersion medium.

One preferred embodiment of the invention provides for an electrochemical energy store having a plurality of electrochemical cells between which extinguishing agent or extinguishing agent additive is at least sectionally disposed. It is particularly preferred for said electrochemical energy store to comprise frameless prismatic electrochemical cells electrically connected by their lateral surfaces or contacts.

A further preferred embodiment of the invention provides for an electrochemical energy store in which at least sections of at least one electrochemical cell are coated or supplied with an extinguishing agent or extinguishing agent additive. Electrochemical energy stores in which at least sections of the electrochemical cells have their lateral surfaces laminated together with the extinguishing agent or extinguishing agent additive are particularly preferred.

A further preferred embodiment of the invention provides for an electrochemical energy store in which the extinguishing agent or extinguishing agent additive is a solid or an elastically deformable material or is contained in such a material. The term solid in this context is also intended to encompass compressed aggregations of powders or foams, particularly elastically deformable foams.

In accordance with a further preferred embodiment of the invention, an electrochemical energy store is provided with a housing having walls which are at least sectionally coated or supplied with an extinguishing agent or extinguishing agent additive.

An electrochemical energy store housing is to be understood as any device which is suited and intended to preventing or hindering material transfer between the components of the electro-chemical energy store and its environment. The housing is preferably also suited and intended to preventing or hindering unwanted exchanges of energy between the electrochemical energy store and its environment, particularly when energy would thereby be exchanged in an unwanted manner, particularly including non-electrically as in thermal or mechanical energy, for example. A housing thus preferably serves in protecting the electrochemical energy store from unwanted influences from its environment as well as protecting the environment from forces or dangers which might come from the electrochemical energy store. However, such housings are frequently not always fully enclosed and, in some cases, are constructed to allow a controlled exchange of gas between the energy store and its environment.

The walls of a housing for such an energy store are those components of the housing which are suited to preventing or hindering an unwanted exchange of material or an unwanted exchange of energy between the energy store and its environment. The walls in particular also include such components of the housing which separate different sections of the housing from one another.

A further preferred embodiment of the invention provides for an electrochemical energy store in which the extinguishing agent or the extinguishing agent additive can absorb or contain several times its volume in water. Particularly preferred in conjunction hereto are gelling agent-based extinguishing agents, particularly those containing so-called superabsorbent-based extinguishing agent additives.

A further preferred embodiment of the invention provides for an electrochemical energy store in which the extinguishing agent or extinguishing agent additive contains at least one polymer, preferably a copolymer, particularly preferably an acrylamide copolymer or a sodium acrylate copolymer.

A further preferred embodiment of the invention provides for an electrochemical energy store in which the extinguishing agent or extinguishing agent additive contains at least one fatty acid ester.

A further preferred embodiment of the invention provides for an electrochemical energy store in which the extinguishing agent or extinguishing agent additive contains at least one tenside.

A further preferred embodiment of the invention provides for an electrochemical energy store in which the extinguishing agent or extinguishing agent additive contains at least one mixture or emulsion of water and at least one fatty acid ester, at least one polymer, preferably a copolymer, particularly preferably an acrylamide copolymer or a sodium acrylate copolymer.

A further preferred embodiment of the invention provides for an electrochemical energy store in which the extinguishing agent contains a mixture or an emulsion of approximately 28% of at least one polymer, approximately 6% of at least one tenside, approximately 23% of at least one ester oil and approximately 43% water.

A further preferred embodiment of the invention provides for an electrochemical energy store in which the extinguishing agent additive is used in combination with water and a mixture or emulsion of approximately 50% of at least one polymer, approximately 10% of at least one tenside and approximately 40% of at least one ester oil.

In accordance with a further preferred embodiment, the carrier substance with which the extinguishing agent additive can be mixed into an extinguishing agent is a coolant flowing through a coolant circuit which is closed during the normal operation of the energy store and which is designed such that the coolant is released from the closed coolant circuit at specific locations in the case of fire and can initiate an extinguishing action at these locations. This allows a targeted initiating of the extinguishing action at specific locations affected by a fire while, at the same time, being able to maintain the cooling action.

In the sense of the present invention, a coolant refers to a flowable material, particularly a gaseous or liquid heat transport medium, which absorbs heat from its surroundings, transports this heat in a flow, and can also release it into its surroundings and, by virtue of its physical properties, is able to transport heat within the heat transport medium in aerodynamic or hydrodynamic flows, particularly also convection currents, by thermal conduction and/or heat transport. Notable examples of general prior art heat transport media include e.g. air, water or other common coolants. Depending upon the concrete application, other gases or liquids are also common, for instance chemically inert (low reactive) gases or liquids such as noble gases or liquefied noble gases or substances having high thermal capacity and/or thermal conductivity.

A flowable material is to be understood in the present context as any material in which flows can develop aerodynamically or hydrodynamically or in which such a flow can be maintained. Examples of such materials are gases and liquids in particular. Flows in this respect can however also be maintained or initiated in a mixture of liquids and/or gases and finely dispersed solids, so-called aerosols, or in colloidal solutions.

A particularly preferential apparatus according to invention comprises a device to stabilize the coolant pressure when the coolant is released from the coolant circuit at specific locations in the event of fire. This embodiment of the invention can be coupled with maintaining the coolant pressure, and thus the cooling effect, to a great or complete degree when the coolant is released from the coolant circuit at the specific locations in order to maintain its extinguishing effect at these locations.

Another preferential embodiment of the invention uses water as the coolant, whereby the coolant flows through the coolant circuit which remains closed during the normal operation of the energy store and is designed such that the water can be released from the closed coolant circuit at specific locations in case of a fire and be mixed with an extinguishing agent additive upon exiting the coolant circuit, wherein a gel or a viscoelastic fluid is formed.

Utilizing an extinguishing agent additive consisting of a mixture of at least one polymer, at least one tenside and at least one ester oil is hereby particularly preferential.

Further particularly preferred is for an additive to consist of a mixture of approximately 50% of at least one polymer, approximately 10% of at least one tenside and approximately 40% of at least one ester oil.

When calculating the mixing ratios, it is preferable to take into account that the advantageous effects of the coolant/extinguisher mixture or additive are based on the viscoelasticity of said coolant/extinguisher mixture and its ability to bind water. The coolant's force of adhesion to smooth surfaces can hereby also be increased. The liquid does not flow off unused.

Suitably calculating the mixing ratios in light of kinetic energy leads to a substantial reduction of the viscosity compared to the dormant stage, particularly in the case of mixtures of polymers, ester oils, tensides and water. Such a mixture can thereby flow through a coolant circuit at low viscosity and, at the same time, exhibit a high viscosity when being released from the coolant circuit at the location of a fire. The fluidity of such mixtures thus primarily depends on the flow rate.

The chemical-physical bonding of the liquid into a gel structure can considerably reduce the liquid's evaporation rate, even at higher temperatures. This considerably reduces the consumption of the liquid. Due to the relatively high layer thickness and the reduced evaporation rate, liquid bonded in a gel structure can initiate an increased cooling effect at the fire's location. This effect is of particular importance when suppressing fires of very high temperatures.

In some preferred embodiments, the extinguishing agent additive preferably has the form of a mixture consisting of P wt % of at least one polymer, T wt % of at least one tenside and E wt % of at least one ester oil, in relation to the additive's total volume, where:

45≦P≦55,

8≦T≦12,

35≦E≦45,

and

P+T+E=100.

The following will draw on preferential embodiments and drawings in describing the invention in greater detail. Shown are:

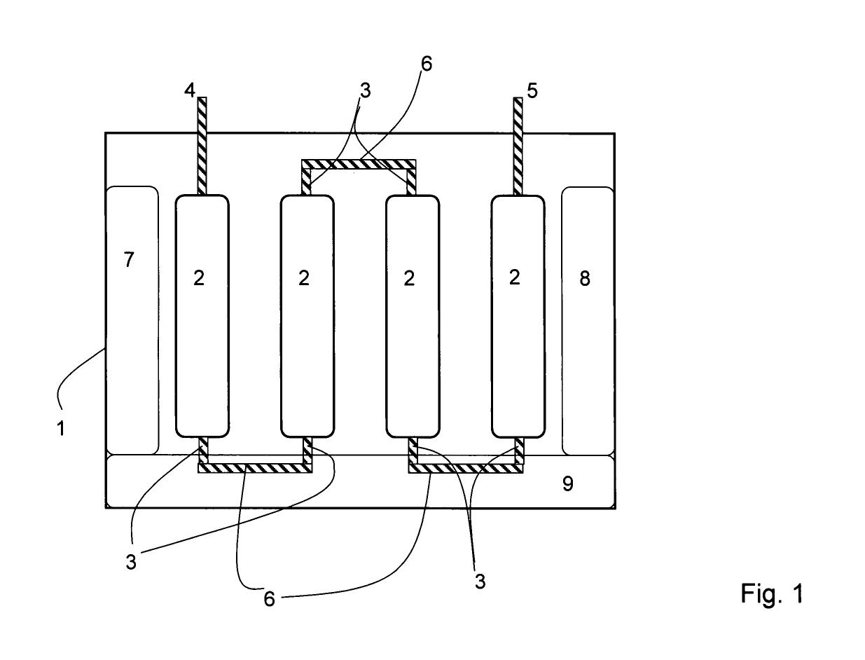

FIG. 1 a first embodiment of the present invention;

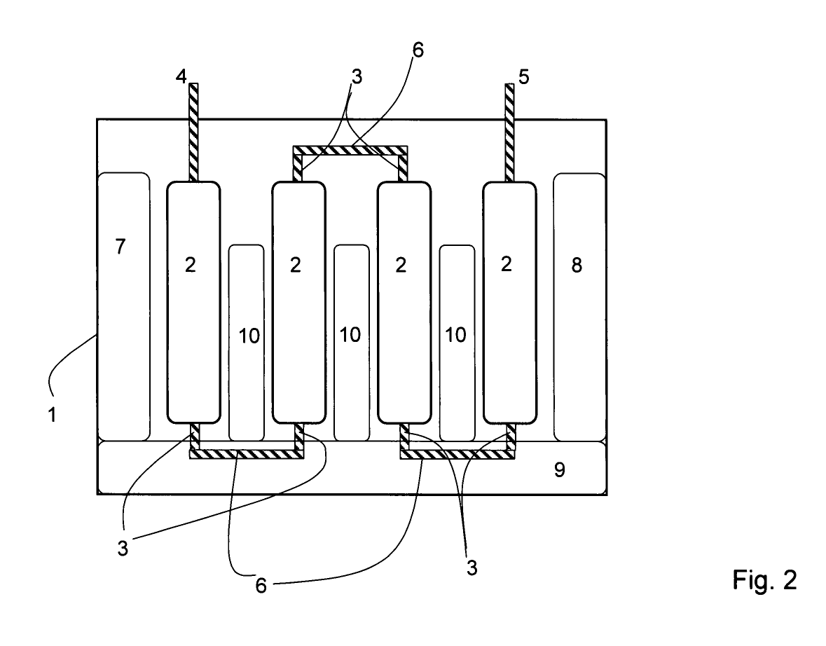

FIG. 2 a second embodiment of the present invention;

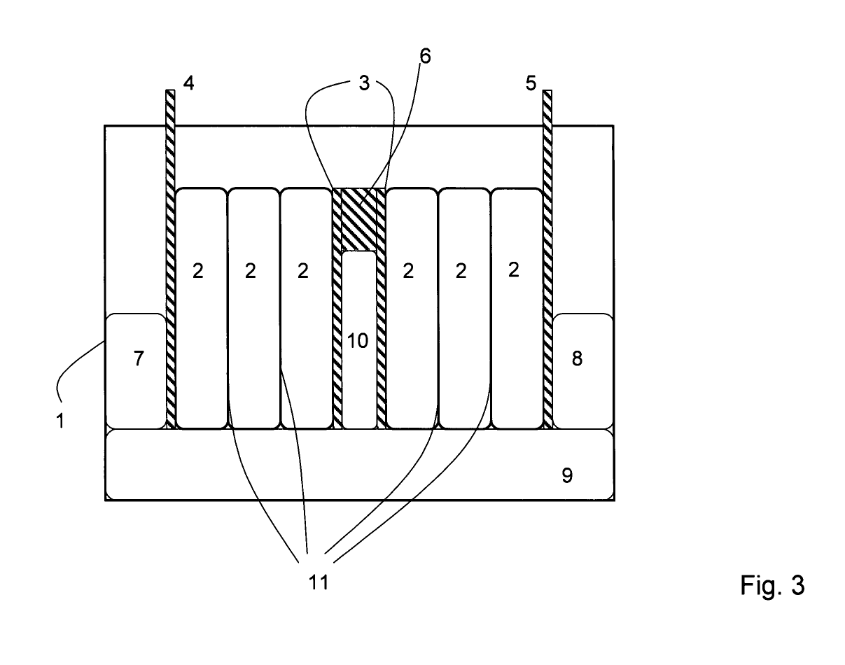

FIG. 3 a third embodiment of the present invention;

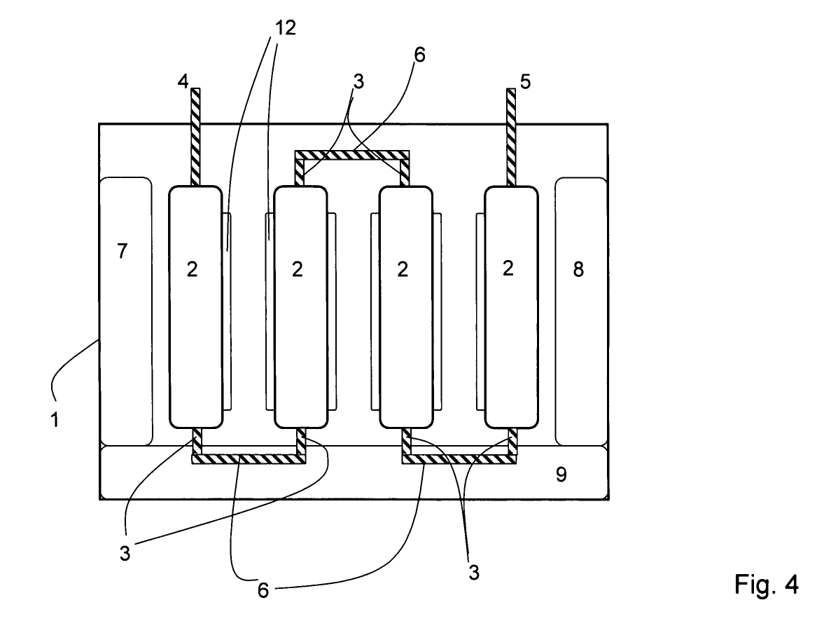

FIG. 4 a fourth embodiment of the present invention;

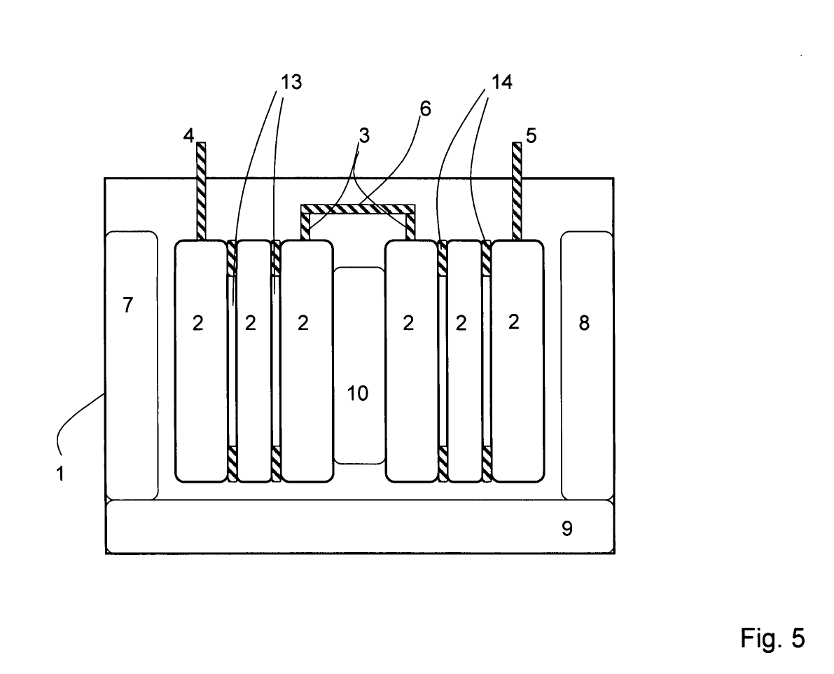

FIG. 5 a fifth embodiment of the present invention;

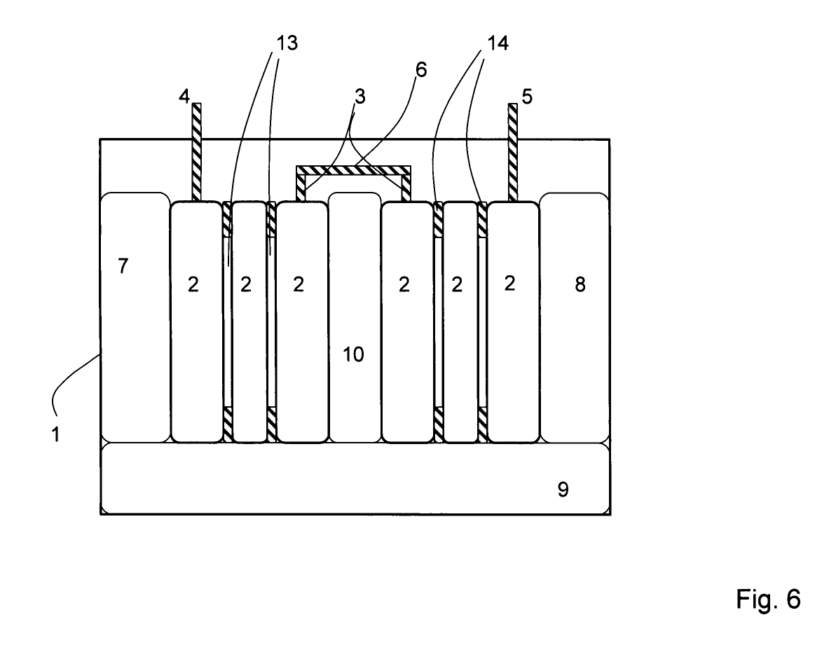

FIG. 6 a sixth embodiment of the present invention; and

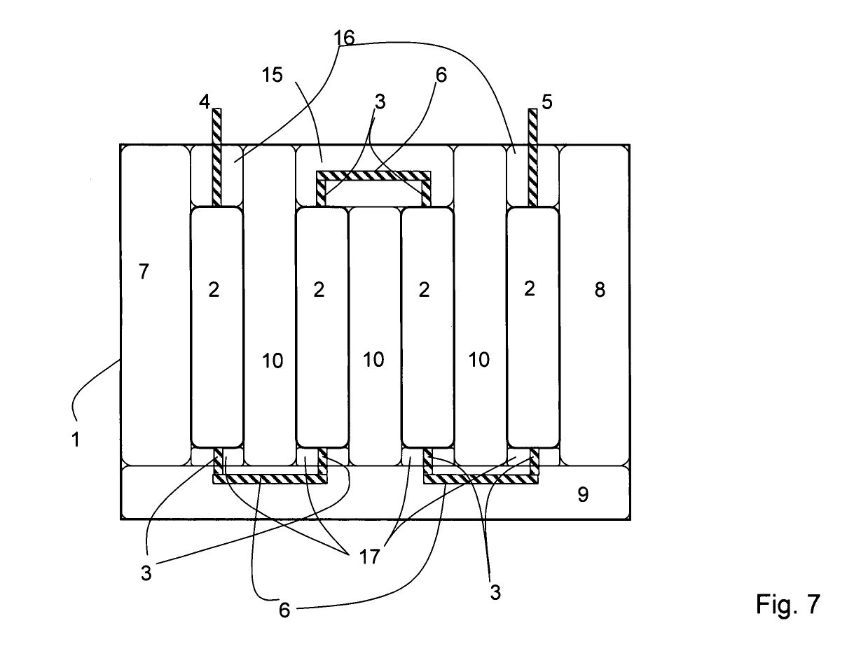

FIG. 7 a seventh embodiment of the present invention.

The embodiment of an inventive electrochemical energy store schematically depicted in FIG. 1 comprises a housing 1, the walls of which are coated or supplied on the inside with an extinguishing agent or extinguishing agent additive 7, 8 and the base of which is coated or supplied with an extinguishing agent or extinguishing agent additive 9. In this embodiment, the electrochemical energy store comprises a plurality of electrochemical cells 2, in this case four, their contacts; i.e. their electrical interconnections 3, being connected into an electrical series connection via electrical connectors 6 so that the sum of the voltage generated by the electrochemical cells 2 shown in FIG. 1 abuts the contacts 4 and 5 leading out the housing.

This embodiment has the advantage over known configurations of electrochemical energy stores that in the case of a fire inside the housing in which burning or flammable materials sink to the base plate of the housing 1 due to the influence of the force of gravity, the extinguishing agents or extinguishing agent additives 7, 8 and 9 applied to the walls and the base plate of the housing initiate a fire-retarding effect on the flammable or burning materials so as to effectively thwart the fire or its spread. Should the coatings 7, 8 and 9 not be an extinguishing agent but rather an extinguishing agent additive, it is advantageous when that substance which results together with the extinguishing agent additive is released by the destruction or the destruction of the burning electrochemical cells 2 and mixes into extinguishing agent with the extinguishing agent additive or can react with same into an extinguishing agent. In other cases, a carrier substance such as e.g. water with which the extinguishing agent additive can mix or bind into an extinguishing agent can be introduced from the outside in the event or fire or to prevent same.

Embodiments of the invention in which the materials with which the housing walls are coated or supplied are compounds also consisting in some areas of an extinguishing agent additive and a carrier substance which yield the extinguishing agent together with the extinguishing agent additive so that said compound mixes or chemically reacts and thereby forms the extinguishing agent in response to the high temperature developing during a fire are also preferential. Other preferred embodiments provide for the extinguishing agent additive to be applied to the inner housing wall or also to the outer housing wall by coating or other means so that upon the external supply of an extinguishing agent or another carrier substance such as e.g. water, the extinguishing agent additive applied to the housing walls or the housing base bonds with the solvent introduced from the outside, preferably water, and thus reacts into extinguishing agent.

One preferred extinguishing agent additive is a mixture or emulsion of at least one polymer, at least one tenside and at least one ester oil. Such mixtures or emulsions mix with water into an extinguishing agent which keeps the water on the burning surfaces for a sustained period of time and thus effects a longer lasting and more effective inhibition of fire and cooling than does water without the extinguishing agent additive. The extinguishing agent additive thereby contains preferably approximately 50% of at least one polymer, preferably approximately 10% of at least one tenside and preferably approximately 40% of at least one ester oil.

In cases in which the extinguishing agent additive is already deposited on the housing walls or on the housing base or on other components of the electrochemical energy store as a mixture or emulsion in combination with its solvent or its carrier substance, in particular in combination with water, the extinguishing agent preferably has a gel-like, particularly viscous consistency and consists preferably of approximately 28% of at least one polymer, approximately 6% of at least one tenside, approximately 23% of at least one ester oil and approximately 43% water.

In conjunction with all the depicted or described examples of execution or embodiments of the invention, the features of which can additionally also be advantageously combined with one another, an extinguishing agent or an extinguishing agent additive which is a gel or a viscous fluid is preferential. Other embodiments of the invention provide for an extinguishing agent or an extinguishing agent additive which is a solid or an elastically deformable material or which is contained in such a solid or elastically deformable material.

In the embodiment of the invention depicted schematically in FIG. 2, additionally to the extinguishing agents or extinguishing agent additives 7, 8 applied to the housing walls and the extinguishing agents or extinguishing agent additives 9 applied to the housing base, extinguishing agents or extinguishing agent additives 10 are disposed between the electrochemical cells 2, wherein the extinguishing agents or extinguishing agent additives are preferably disposed in sections as depicted schematically in FIG. 2.

FIG. 3 shows an embodiment of the invention where the electrochemical cells 2 do not exhibit any electrical contact 3 leading out of the cell housing or out of the cell casing, but rather in which the electrochemical cells 2 contact through their cell walls or lateral cell casing surfaces 11 so as to thereby effect an electrical series connection of a plurality of cells 2 such that there is contact between the electrically conductive or at least sectionally conductive cell walls as shown in FIG. 3.

Electrical contacts 4 and 5 leading out of the housing 1 in contact with the cell walls of the outer electrochemical cells are provided at the end of a cell stack of a plurality of cells 2. In this embodiment, the extinguishing agents or extinguishing agent additives are disposed in sections on the cell walls 7, 8 or applied to the base plate 9. The cell stack shown in FIG. 3 consists of two partial stacks, each containing three respective cells, and connected by electrical contacts 3 and 6. The electrical connector 6 is designed such that an extinguishing agent or extinguishing agent additive 10 can be disposed in areas between the two partial cell stacks.

FIG. 4 schematically depicts an embodiment of the invention in which the electrochemical cells, or their lateral walls respectively, are at least sectionally coated with an extinguishing agent or extinguishing agent additive 12. When the cell casing is broken open, the extinguishing agent or extinguishing agent additive applied to the cell casing walls can inhibit fire developing due to the escape of burning or flammable material.

FIG. 5 shows an embodiment of the invention in which the lateral surfaces of the electrochemical cells 2 are at least sectionally laminated together with an extinguishing agent 13 or with an extinguishing agent additive 13. In those areas of the cell walls in which no extinguishing agent or no extinguishing agent additive 13 is provided, contact elements or contact layers of electrically conductive material 14 effecting the electrical interconnecting of the cells are preferably provided. At those points where there is no electrical contact 14 between electrochemical cells and where an extinguishing agent or extinguishing agent additive 10 is preferably disposed between such electrochemical cells, the contact 3 protruding out of the cell housing or out of the cell casing can interconnect the cells via an electrically conductive connector 6 as in the other embodiments of the invention.

FIG. 6 shows a design variant of the embodiment depicted in FIG. 5 in which the extinguishing agent or extinguishing agent additive are spread on the wall coatings 7 and 8 and the base coating 9 to such an extent that the coatings extend to the edges and walls of the electrochemical cells. The extinguishing agent or extinguishing agent additive 10 disposed between the partial cell stacks is also spread to such an extent so as to virtually completely fill the space between the electrochemical cells and the space below the electrochemical cells. In this embodiment of the invention, the fire-retarding and cooling action of the extinguishing agent initiates a direct effect on the housing or the casing walls of the electrochemical cells 2.

FIG. 7 shows a further design variant of the embodiment of the invention depicted in FIGS. 5 and 6 in which also the spatial area above and below the cell housing edges, there where the contact preferably leads out of the cell housings or casings, is filled with extinguishing agent or extinguishing agent additives 15, 16 and 17.

The following reference numerals were used in conjunction with the description of the present invention referring to the figures:
1 housing
2 electrochemical cell
3 electrical connection (contact) of an electrochemical cell
4, 5 contact protruding from the housing
6 electrically conductive connection between contacts
7, 8 extinguishing agent or extinguishing agent additive disposed on the inner side of a housing wall
9 extinguishing agent or extinguishing agent additive disposed on the base of the housing
10 extinguishing agent or extinguishing agent additive disposed between electrochemical cells
11 contacting cell walls
12 coating a cell wall with an extinguishing agent or extinguishing agent additive
13 extinguishing agent or extinguishing agent additive disposed or laminated between electrochemical cells
14 electrically conductive connection between cell walls
15, 16, 17 extinguishing agent or extinguishing agent additive disposed at the cell edges

1-16. (canceled)

17. An electrochemical energy store, comprising:
a plurality of electrochemical cells comprising contacts; and
intermediate elements between each two respective adjacent electrochemical cells or between an electrochemical cell and a housing wall, wherein said intermediate elements consist of an extinguishing agent or an extinguishing agent additive or contain or comprise an extinguishing agent or extinguishing agent additive, and wherein the spatial areas above and below the cell housing edges where the contacts lead out of the cell casings are filled with extinguishing agent or extinguishing agent additives.

18. The electrochemical energy store according to claim 17, wherein the plurality of electrochemical cells include frameless prismatic electrochemical cells electrically connected by lateral surfaces or contacts of the frameless prismatic electrochemical cells.

19. The electrochemical energy store according to claim 17, wherein at least sections of at least one of the plurality of electrochemical cells are coated or supplied with an extinguishing agent or an extinguishing agent additive.

20. The electrochemical energy store according to claim 18, wherein at least sections of the frameless prismatic electrochemical cells have their lateral surfaces laminated together with an extinguishing agent or an extinguishing agent additive.

21. The electrochemical energy store according to claim 17, wherein the extinguishing agent or extinguishing agent additive respectively is a gel or a viscous fluid.

22. The electrochemical energy store according to claim 17, wherein the extinguishing agent or extinguishing agent additive respectively is a solid or an elastically deformable material or is contained in a solid or an elastically deformable material.

23. The electrochemical energy store according to claim 17, wherein at least one wall of the energy store housing is at least sectionally coated or provided with an extinguishing agent or with an extinguishing agent additive.

24. The electrochemical energy store according to claim 17, wherein the extinguishing agent or extinguishing agent additive is configured to absorb or contain several times its volume in water.

25. The electrochemical energy store according to claim 17, wherein the extinguishing agent or extinguishing agent additive comprises at least one polymer.

26. The electrochemical energy store according to claim 25, wherein the at least one polymer is an acrylamide copolymer or a sodium acrylate copolymer.

27. The electrochemical energy store according to claim 17, wherein the extinguishing agent or extinguishing agent additive comprises at least one fatty acid ester.

28. The electrochemical energy store according to claim 17, wherein the extinguishing agent or extinguishing agent additive comprises at least one tenside.

29. The electrochemical energy store according to claim 17, wherein the extinguishing agent or extinguishing agent additive comprises at least one mixture or emulsion of water and at least one fatty acid ester, and at least one polymer.

30. The electrochemical energy store according to claim 17, wherein the at least one polymer is an acrylamide copolymer or a sodium acrylate copolymer.

31. The electrochemical energy store according to claim 17, wherein the intermediate elements comprise the extinguishing agent, and wherein the extinguishing agent comprises a mixture or an emulsion of:
approximately 28% of at least one polymer;
approximately 6% of at least one tenside;
approximately 23% of at least one ester oil; and
approximately 43% water.

32. The electrochemical energy store according to claim 17, wherein the intermediate elements comprise the extinguishing agent additive, and wherein the extinguishing agent additive is used in combination with water and contains a mixture or an emulsion of:
approximately 50% of at least one polymer;
approximately 10% of at least one tenside; and
approximately 40% of at least one ester oil.

33. A method of manufacturing an electrochemical energy store, the method comprising:
disposing intermediate elements between each two respective adjacent electrochemical cells of a plurality of electrochemical cells having contacts or between an electrochemical cell and a housing wall, wherein said intermediate elements consist of an extinguishing agent or an extinguishing agent additive or contain or comprise an extinguishing agent or extinguishing agent additive, and wherein spatial areas above and below the cell housing edges where the contacts lead out of the cell casings are filled with extinguishing agent or extinguishing agent additives.

34. A method, comprising:
fighting or preventing a fire by using intermediate elements disposed between each two respective adjacent electrochemical cells of a plurality of electrochemical cells having contacts or between an electrochemical cell and a housing wall, wherein said intermediate elements consist of an extinguishing agent or an extinguishing agent additive or contain or comprise an extinguishing agent or extinguishing agent additive, and in which spatial areas above and below the cell housing edges where the contacts lead out of the cell casings are filled with extinguishing agent or extinguishing agent additives.
